(19) United States
(12) Patent Application Publication
(10) Pub. No.: US 2013/0250960 A1
(43) Pub. Date: Sep. 26, 2013

(54) System and Method for Routing Service Request Messages

(71) Applicants: Sean Hickman, Glastonbury, CT (US); Surajit Pal, Glen Allen, VA (US); Youyi Mao, Woodbridge, CT (US); Rickey Tang, Southwick, MA (US)

(72) Inventors: Sean Hickman, Glastonbury, CT (US); Surajit Pal, Glen Allen, VA (US); Youyi Mao, Woodbridge, CT (US); Rickey Tang, Southwick, MA (US)

(21) Appl. No.: 13/425,660

(22) Filed: Mar. 21, 2012

(51) Int. Cl. H04L 12/56

(52) U.S. Cl. 370/398

(57) ABSTRACT

A service request message is received. The service request message includes a payload portion and a context portion. Constituency specific attributes of the service request message and domain specific attributes of the service request message are identified from the payload portion. Context attributes, a service consumer identity, a service name and a service version are identified from the context portion. A service registry is queried using the service consumer identity, the service name and the service version to identify service metadata. An endpoint address to route the service request message is identified using the one or more constituency specific attributes, the one or more domain specific attributes and the service metadata.

### FIELD OF THE INVENTION

The invention generally relates to systems and method for routing service request messages.

### SUMMARY OF THE INVENTION

The present invention relates to a method, system and non-transitory computer readable medium for routing a service request message. The received service request message includes a payload portion and a context portion. Constituency specific attributes and domain specific attributes of the service request message are identified from the payload portion. Context attributes, a service consumer identity, a service name and a service version are identified from the context portion. A service registry is queried using the service consumer identity, the service name and the service version to identify service metadata. An endpoint address to route the service request message is identified using the one or more constituency specific attributes, the one or more domain specific attributes and the service metadata.

### BRIEF DESCRIPTION OF THE DRAWINGS

The foregoing summary, as well as the following detailed description of various embodiments, will be better understood when read in conjunction with the appended drawings. It should be understood, however, that the invention is not limited to the precise arrangements and instrumentalities shown.

In the drawings:

FIG. 1 illustrates an exemplary system diagram for implementing the methodologies described herein; and

FIG. 2 illustrates an exemplary methodology in accordance with the embodiments described herein.

### DETAILED DESCRIPTION

A request message for a business service or transaction for a client application can potentially be served by one of the several back end systems of an enterprise. For example, for an enterprise in the health payor industry, such back end systems may relate to membership, eligibility, claim, product, provider, pricer and others. For some enterprises, certain of these backend systems may have multiple instances a serving business or a geographic region. The present invention relates to a routing system that can be implemented within an organization to allow for more efficient routing of messages to appropriate back-end systems. While the invention is described herein with reference to the healthcare payor industry for illustration purposes, it will be understood by those skilled in the art that the claimed invention can be used in other contexts (i.e., with reference to domains other than the healthcare domain model) and is not limited to the healthcare payor industry in particular.

The systems and methodologies described herein provide a comprehensive framework for content-based routing in a federated environment. In routing to the various back end systems, the integration layer, implemented as an Enterprise Service Bus (“ESB”), determines the destination system, or systems in the case of aggregation, by inspecting data fields in a particular domain (e.g., healthcare domain) of the request message content. Matrix routing logic is employed, based on the constituent represented by the requestor (e.g., member, provider, broker etc.) and the domain to which the requested service belongs.

In connection with the systems and methodologies described herein, data field values in the request are evaluated against a set of routing rules to determine the backend system or system that will process the request; routing rules are driven by the metadata stored in persistent stores, e.g., a relational database system; and a software component takes the values of certain fields from the request as input, applies rules based on the metadata in the persistent store, determines backend systems that will process the request, in terms of their logical names, and returns those logical names as output.

In general, the system described herein is comprised of two primary components—(1) a persistent store to store routing metadata and (2) a software implementation of routing logic using the routing metadata. The router may be implemented using a relation database for storing routing metadata and an application server environment, such as J2EE, for implementing the routing logic as software services. The routing services may be exposed with both web services/REST services interfaces and native interfaces. The external systems can choose one type of interface that is the most appropriate. The approach described herein uses a general routing framework to accommodate the different router variations and to support many different constituencies (i.e., business users) and associated domains. The routing logic is wrapped into a utility service for each constituency, which different ESB instances can access. In the healthcare payor context, for example, two such constituencies are Member and Provider.

The system described herein can be used when the service consumer identity along with the service metadata and the context of request are not sufficient to route a request to the right service provider. Additional information from the message payload is needed to determine the target back-end system for the request.

The routing service for the Member constituency, for example, contains a component for each domain to determine the service provider for a request in that domain. The domain specific routing logic is exposed as an operation for the service. The inputs for the domain specific routing for Member constituency are context attributes, service metadata, member attributes and domain specific attributes. The output from the routing logic is one or a set of logical names of service providers in that domain. Note that more than one service provider signifies an aggregation condition. The ESB then finds the appropriate end-point addresses by consulting service meta-data from the registry and repository. The various routing components use a database for to obtain the routing metadata.

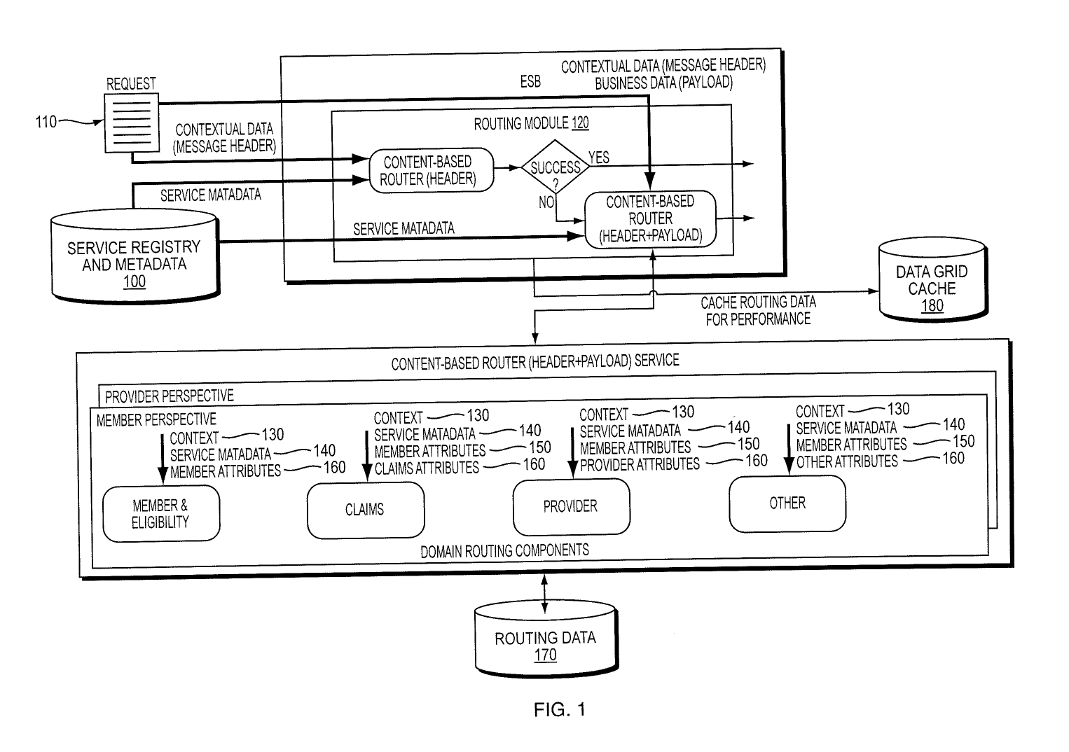

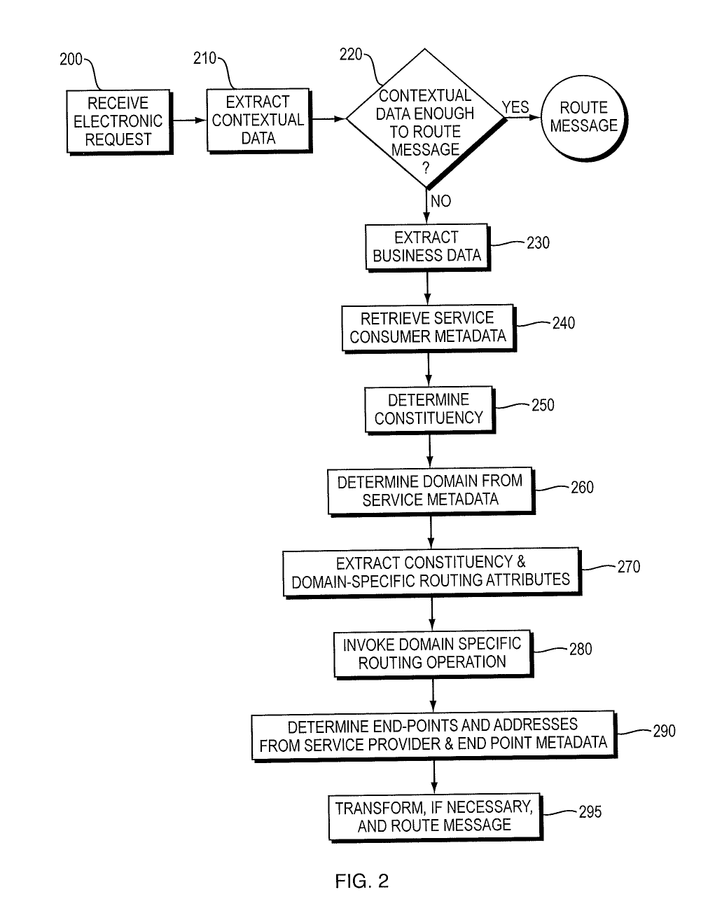

The steps involved with routing messages in accordance with the embodiments described herein are illustrated with reference to FIGS. 1 and 2. An electronic request 110 is received, in step 200. The electronic request 110 includes contextual data in the message header and business data in the payload. The contextual data is extracted from the message, in step 210. The routing module 120 determines, in step 220, whether the contextual data in the message header is enough to route the message. If so, the message is routed accordingly. If not, additional data is used by the routing module to determine how to route the message. In particular, business data is extracted from the payload of the request by the routing module in step 230. In addition, service consumer metadata is retrieved from the service registry 100, in step 240, based on the service consumer identity in the context part of the message. The constituency of the service consumer is determined, in step 250, which then indicates the constituency of the routing service for the content-based router (Header+Payload). The domain for the service is determined from the service metadata, in step 260. This informs what operation to invoke on the routing service for the constituency. The constituency and domain-specific routing attributes are extracted from the message payload, in step 270. In step 280, the domain specific routing operation is invoked on the constituency-specific routing service by passing the following types of attributes to routing data database 170: Context attributes 130; Service Metadata 140; Constituency-specific attributes (e.g., member attributes or provider attributes in the example shown) 150; and Domain-specific attributes (e.g., member & eligibility, claims, provider, other in the example shown) 160. In step 290, the returned service provider name(s) is used to determine the end-point(s) and the corresponding address(es) from the service provider and the end-point(s) metadata. Note that multiple service providers signify an aggregation situation (e.g., a scenario in which a request is routed to multiple back-end systems and the responses from those systems are aggregated before returning to the requesting application). In step 295, the metadata of the service provider endpoint is used to transform, if necessary, and route the message. Note that data grid cache 180 may be used to cache routing data to improve performance of the system.

Service registry 100 and routing data database 170 may each be comprised of one or more relational databases; however, other data organizational structure may be used without departing from the scope of the present invention. Routing module 120 is a software module comprising computer-readable instructions that are stored in non-transitory memory and executed by a computer processor. The computer processor is therefore specially programmed to implement the functionality described herein.

Exemplary routing attributes for the various domains for a Member constituency are provided in Tables 1 and 2 below. It will be understood by those skilled in the art that the Member constituency, referring to the healthcare payor domain, is shown for illustration purposes only.

TABLE 1
Common Attributes from Context and Metadata

| Source | Attributes | Responsibility | Source Object |
|---|---|---|---|
| Context | Service Name | Service Consumer | Request |
| (Message | Service Version | Service Consumer | Request |
| Header) | Sender Application | Service Consumer | Request |
| Metadata | Service Consumer | ESB | Service Consumer |
| (Registry | Constituency | | |
| and | Service Domain | ESB | Service |
| Repository) | Message Format | ESB | ESB Endpoint |
| | Environment | ESB | ESB Endpoint, |
| | | | Provider |
| | | | Endpoint |
| | Service Name | ESB | Provider Endpoint |
| | Service Version | ESB | Provider Endpoint |
| | Message Format | ESB | Provider Endpoint |
| | Transport | ESB | Provider Endpoint |
| | Endpoint Address | ESB | Provider Endpoint |

TABLE 2
Domain Specific Routing Attributes in Member Constituency

| Domain | Member | |
|---|---|---|
| Name | (Constituency) | Domain Attributes |
| Membership | Subscriber ID | |
| & Eligibility | Group ID | |
| | | Plan ID |
| Benefits & | Subscriber ID | Product ID/ |
| Products | | Subgroup ID |
| | Group ID | |
| Claims | Subscriber ID | Claim Number/ |
| | | Claim Revision |
| | | Number (sequence) |
| | | & conditionally a |
| | | member/membership |
| | | attribute |
| | Group ID | |
| Provider | Subscriber ID | Static |
| | Group ID | |
| Pricer | Subscriber ID | Static |
| | Group ID | |
| Pharmacy | Subscriber ID | Static |
| | Group ID | |

Note that the term ‘static’ in the Domain Attributes column signifies that there is a one-to-one relationship between the Membership system and domain-specific system.

The routing logic is illustrated with an example of a service in the claims domain invoked by a Member constituency, as follows. A sample request message is shown below with the key data elements for routing.

<soapenv:Envelope xmlns:soapenv=“http://schemas.xmlsoap.org/soap/envelope/”
xmlns:head=“http://wellpoint.com/esb/header” xmlns:con=“http://wellpoint.com/esb/context”
xmlns:cla=“http://wellpoint.com/service/claims”>

<soapenv:Header>

<con:Context>

<con:srvcName>ClaimsService</con:srvcName>
<con:srvcVersion>1.0</con:srvcVersion>
<con:operName>Search_Claims_Ex</con:operName>

<con:senderApp>EPORT</con:senderApp>

................................................................

</con:Context>

</soapenv:Header>
<soapenv:Body>

<cla:ClaimsService_Search_Claims_Ex_Request>

<cla:SearchClaimsExRequest>

<cla:StaticData>

<cla:memberLookupId>069M62343</cla:memberLookupId>

<cla:memberSequenceNumber/>

<cla:claimNumber/>

<cla:claimTypeCode>MEDICAL</cla:claimTypeCode>
<cla:serviceStartDate>20090516</cla:serviceStartDate>
<cla:serviceEndDate>20110516</cla:serviceEndDate>
<cla:providerOrganizationId/>
<cla:providerOrganizationIdSuffix/>
<cla:icd9DiagnosisCode/>
<cla:groupId>00180894</cla:groupId>
<cla:billedChargeAmount/>
<cla:latestClaimRevisionInd/>
<cla:eligibilityTypeCode/>
<cla:itsClaimSerialNumber/>
<cla:membershipCode/>
<cla:selectedPageNumber/>
<cla:NextPage/>
<cla:preAuthorizationNumber/>
<cla:prescriptionTypeCode/>
<cla:pharmacyNabpIdentifier/>
<cla:sorClaimStatusCode/>

</cla:StaticData>

</cla:SearchClaimsExRequest>

</cla:ClaimsService_Search_Claims_Ex_Request>

</soapenv:Body>

</soapenv:Envelope>

The service consumer metadata is retrieved from the service registry based on the service consumer identity in the context part of the message.

The input for the query to Service Registry is:
Context.srvcName=‘ClaimsService’
Context.srvcVersion=‘1.0’
Context.senderApp=‘EPORT’ (ePortal application)

The output from the query to Service Registry is:
Metadata.ServiceConsumer.constituency=‘Member’
Metadata.Service.domain=‘Claims’
Metadata.ESB.Endpoint.messageFormat=‘SOAP’
Metadata.ESB.Endpoint.environment=‘PROD’

The constituency of the service consumer is determined. In this example, the constituency is ‘Member’.

The domain for the service is determined from the service metadata. This informs the operation that is to be invoked on the routing service for the constituency. In this example, the domain is ‘Claims’.

The constituency and domain-specific routing attributes are extracted from the message payload.

In this example, the constituency attributes from the message are:
Subscriber ID a.k.a. memberLookupId=‘069M62343’
Group ID a.k.a. groupId=‘00180894’

In this example, the domain attributes from the message are:
Claim Number a.k.a claimNumber=[optional, not specified]
Claim Revision Number a.k.a. claimRevisionNumber=[optional, not specified]

The domain specific routing operation is invoked on the constituency-specific routing service.
Routing Service:operation->MemberRouter:routeClaimsDomain( )

The input to the router operation is:

a. Context attributes
Context.srvcName=‘Search_Claims_Ex’
Context.srvcVersion=‘1.0’
Context.senderApp=‘EPORT’ (ePortal application)

b. Service Metadata
Metadata.ServiceConsumer.constituency=‘Member’
Metadata.Service.domain=‘Claims’
Metadata.ESB.Endpoint.messageFormat=‘SOAP’
Metadata.ESB.Endpoint.environment=‘PROD’

c. Constituency-specific attributes
Subscriber ID a.k.a. memberLookupId=‘069M62343’
Group ID a.k.a. groupId=‘00180894’

d. Domain-specific attributes
Claim Number a.k.a claimNumber=[optional, not specified]
Claim Revision Number a.k.a. claimRevisionNumber=[optional, not specified]

The output from the router operation is:
The destination logical system name(s): FCTCR (Central Facets)

The returned service provider name(s) is used to determine end-point(s) and the corresponding address(es) from the service provider and the end-point(s) metadata from the service registry.

The input for the query to Service Registry is:
Context.srvcName=‘ClaimsService’
Context.srvcVersion=‘1.0’
Context.senderApp=‘CCBCR’
Metadata.ServiceConsumer.constituency=‘Member’
Metadata.Service.domain=‘Claims’
Metadata.ESB.Endpoint.messageFormat=‘SOAP’
Metadata.ESB.Endpoint.environment=‘PROD’
Metadata.ServiceProvider=‘FCTCR’

The output from the query to Service Registry is:
Metadata.ServiceProvider.Endpoint.messageFormat=‘SOAP’
Metadata.ServiceProvider.Endpoint.transport=‘HTTP’
Metadata.ServiceProvider.Endpoint.address=‘https://service.wellpoint.com/fctcr/claims’

The metadata of the service provider endpoint is used to transform the message, if necessary. In this example, Metadata.ESB.Endpoint.messageFormat and Metadata. ServiceProvider.Endpoint.messageFormat are the same format (SOAP), so transformation is not necessary.

The message is then routed using the endpoint address. In this example, the service using is invoked the HTTP URL: ‘https://service.wellpoint.com/fctcr/claims’.

It will be appreciated by those skilled in the art that changes could be made to the examples and various embodiments described above without departing from the broad inventive concept thereof. It is understood, therefore, that this invention is not limited to the particular examples and embodiments disclosed, but it is intended to cover modifications within the spirit and scope of the present invention as defined by the appended claims.

What is claimed is:

1. A computerized method comprising:
receiving a service request message, the service request message comprising a payload portion and a context portion;
identifying from the payload portion one or more constituency specific attributes of the service request message and one or more domain specific attributes of the service request message;
identifying from the context portion one or more context attributes, a service consumer identity, a service name and a service version;
querying a service registry using the service consumer identity, the service name and the service version to identify service metadata; and
identifying an endpoint address to route the service request message using the one or more constituency specific attributes, the one or more domain specific attributes and the service metadata.

2. A non-transitory computer-readable medium comprising instructions which, when executed by one or more processors, cause the one or more processors to perform a method comprising:
receiving a service request message, the service request message comprising a payload portion and a context portion;
identifying from the payload portion one or more constituency specific attributes of the service request message and one or more domain specific attributes of the service request message;
identifying from the context portion one or more context attributes, a service consumer identity, a service name and a service version;
querying a service registry using the service consumer identity, the service name and the service version to identify service metadata; and
identifying an endpoint address to route the service request message using the one or more constituency specific attributes, the one or more domain specific attributes and the service metadata.

3. A system comprising:
memory operable to store at least one program; and
at least one processor communicatively coupled to the memory, in which the at least one program, when executed by the at least one processor, causes the at least one processor to:
receive a service request message, the service request message comprising a payload portion and a context portion;
identify from the payload portion one or more constituency specific attributes of the service request message and one or more domain specific attributes of the service request message;
identify from the context portion one or more context attributes, a service consumer identity, a service name and a service version;
query a service registry using the service consumer identity, the service name and the service version to identify service metadata; and
identify an endpoint address to route the service request message using the one or more constituency specific attributes, the one or more domain specific attributes and the service metadata.
